(19) United States
(12) Patent Application Publication
(10) Pub. No.: US 2024/0020473 A1
(43) Pub. Date: Jan. 18, 2024

(54) Domain Based Text Extraction

(71) Applicant: L&T TECHNOLOGY SERVICES LIMITED, Chennai (IN)

(72) Inventors: Madhusudan Singh, Bangalore (IN); Aritra Ghosh Dastidar, Kolkata (IN); VV Nirmal Ramesh Rayulu, Hyderabad (IN); Kaushik Halder, Kolkata (IN); Ajay Sha, Alipurduar (IN)

(21) Appl. No.: 17/535,603

(22) Filed: Nov. 25, 2021

(51) Int. Cl. G06F 40/279; G06V 30/262

(52) U.S. Cl. CPC G06F 40/279; G06V 30/262

(57) ABSTRACT

This disclosure relates to a method and system for extracting information from contents of an input file. The method may include identifying text data from the input file, receiving a text input from a user for identifying relevant text entities from the plurality of text entities, and automatically generating a search pattern corresponding to the text input. The method may further include determining a pattern associated with each of the plurality of text entities, and mapping the search pattern corresponding to the text input with patterns associated with the plurality of text entities. The method may further include identifying one or more matching patterns from the patterns associated with the plurality of text entities based on the mapping, and extracting, from the plurality of text entities, relevant text entities corresponding to the one or more matching patterns.

### TECHNICAL FIELD

This disclosure relates generally to data extraction, and more particularly to a method and a system for extracting text information from contents of an input file, using one or more data extraction approaches.

### BACKGROUND

Text extraction techniques have assumed importance lately. For example, extraction techniques, such as Optical Character Recognition (OCR) may allow a user extract text data from a file, such as an image or a Portable Document Format (PDF) file. Further, it may be desirable to extract relevant information and generate expressions using the extracted relevant information.

Some available techniques may allow to extract textual information from input files and generate expressions using the extracted information, when the input files include tags, or a pattern can be identified in the identified text. However, in complex documents, in which no tags may be present or no pattern can be identified, it is difficult to extract relevant information or generate expressions.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is functional block diagram of an exemplary system for extracting information from contents of an input file, in accordance with some embodiments of the present disclosure.

FIG. 2 is a functional block diagram of a Natural Language Processing (NLP) metadata extract framework, in accordance with some embodiments of the present disclosure.

FIG. 3 is a block diagram of a spell check system, in accordance with some embodiments of the present disclosure.

FIG. 4 is a block diagram of a recommendation system, in accordance with some embodiments of the present disclosure.

FIG. 5 is a block diagram of a metadata update system, in accordance with some embodiments of the present disclosure.

FIGS. 6-8 are flowcharts of a method of extracting information from contents of an input file, in accordance with various embodiment of the present disclosure.

FIG. 9 is a snapshot of an exemplary input file having a noisy entity, from which information is to be extracted, in accordance with some embodiments of the present disclosure.

FIG. 10 is a snapshot of another exemplary input file, from which information is to be extracted, in accordance with various embodiment of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

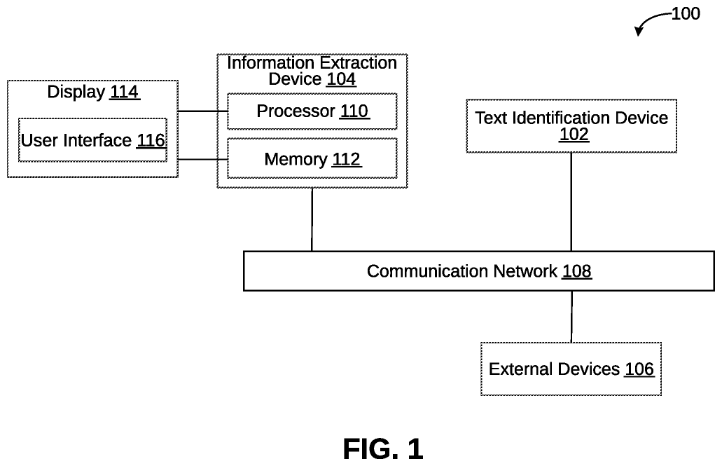

Referring now to FIG. 1, a block diagram of an exemplary system 100 for extracting information from contents of an input file is illustrated, in accordance with some embodiments of the present disclosure. The system 100 may include a text identification device 102. In some embodiments, the text identification device 102 may identify text data from the contents of an input file. For example, the input file may be an image or a Portable Document Format (PDF) file. The identified text data may include a plurality of text entities. As such, in some embodiments, the text identification device 102 may use Optical Character Recognition (OCR) technique for identifying the text data from the input file. In alternate embodiments, the text identification device 102 may use any other technique known in the art for identifying the text data from the input file.

The system 100 may further include an information extraction device 104 communicatively to the text identification device 102. For example, the information extraction device 104 may be configured to extract relevant information from the plurality of text entities identified from the input file by the text identification device 102. In some embodiments, in order to extract information, the information extraction device 104 may receive a text input from a user for identifying relevant text entities from the plurality of text entities, and automatically generate a search pattern corresponding to the text input. The information extraction device 104 may further determine a pattern associated with each of the plurality of text entities, and map the search pattern corresponding to the text input with patterns associated with the plurality of text entities. The information extraction device 104 may further identify one or more matching patterns from the patterns associated with the plurality of text entities based on the mapping, and extract, from the plurality of text entities, relevant text entities corresponding to the one or more matching patterns.

The system 100 may further include a display 114. In some embodiments, the information extraction device 104 may include one or more processors 110 and a computer-readable medium (for example, a memory) 112. The computer-readable storage medium 112 may store instructions that, when executed by the one or more processors 110, cause the one or more processors 110 to generate expressions based on contents of an input file, in accordance with aspects of the present disclosure. The computer-readable storage medium 112 may also store various data (for example, identified text data, value entity data, pattern entity data, and the like) that may be captured, processed, and/or required by the system 100. The system 100 may interact with a user via a user interface 116 accessible via the display 114. The system 100 may also interact with one or more external devices 106 over a communication network 108 for sending or receiving various data. The external devices 106 may include, but may not be limited to, a remote server, a digital device, or another computing system.

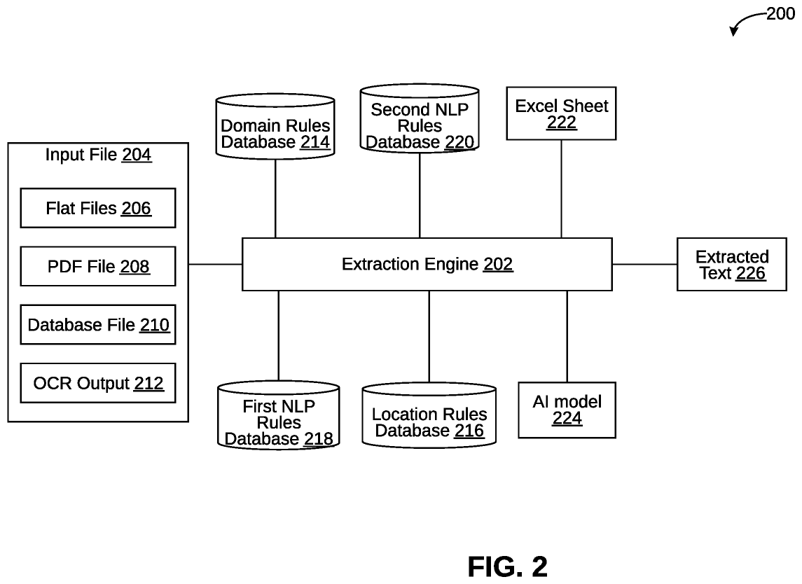

Referring now to FIG. 2, a functional block diagram of a Natural Language Processing (NLP) metadata extraction framework 200 is illustrated, in accordance with some embodiments of the present disclosure. It may be noted that the NLP metadata extraction framework 200 may be implemented in the system 100, and in particularly, in the information extraction device 104. The NLP metadata extraction framework 200 may include various modules that perform various functions so as to extract information from contents of an input file. In some embodiments, an extraction engine 202 may extract/identify text data from contents of an input file 204. The input file 204 may be a flat file 206, or a PDF file 208, or a database file 210, or an OCR output 212.

The extraction engine 202 may further receive one or more domain rules from a domain rules database 214. Further, in some embodiments, the domain rules database 214 may be based on “if—then” rules (rather than through conventional procedural code). It may be noted that domain rules may be used to determine a domain-based name associated with each of the plurality of text entities. The domain-based name may be determined based on mapping each of the plurality of text entities with a list of domain-based names stored in a data depository (not shown in FIG. 1). For example, if the identified data includes a text entity belonging to a PIN code of a city of a country, then, the domain-based database may determine a domain name, i.e., name of the city having that PIN code, for example, by mapping the PIN code with a list of domain-based names stored in a data repository.

The extraction engine 202 may further receive one or more location rules from a location rules database 216. It may be noted that, in some embodiments, the location rules may be used to determine location associated with an entity from the text data in the input file, based on an OCR output. The location may be determined upon first identifying a type associated with the input file, and determining a location of one or more relevant text entities in the input file, based on the type associated with the input file. Once the location of the relevant text entities is determined, the relevant text entities may be extracted from the input file, based on the location. It may be noted that the one or more location rules may be more relevant in case of input data comprising a table, i.e., input data arranged in a tabular format; however, the one or more location rules may be applicable to any other types of input data as well, for example, documents with free text.

By way of example, the type of the input file may be that of an “Aadhar” card. It may be further understood that in the documents like “Aadhar” card, the data may be present in a specific format. As such, the location of the relevant text entities may be predetermined based on a template corresponding to the type associated with the input file, stored in the data repository. For example, the location of text entities “Name” and “Address” (of the concerned person) may be in the middle of the document, and this information may be available and stored in the database of the system 100. In particular, the location may be based on (x, y) coordinates. In the above example, the location of the text entities “Name” and “Address” may be within a region defined by (x, y) coordinates (5, 10) to (15, 15). Therefore, once the type of the document is identified as “Aadhar” card, the system 100 may access the above location to extract the relevant text entities (i.e., “Name” and “Address”) from that location.

The extraction engine 202 may further receive one or more first NLP rules from a first NLP rules database 218. It may be noted that the first NLP rules database 218 may create a Regular Expression (Regex) based on NLP rules provided for values of ground truth/attributes. As it will be appreciated by those skilled in the art, a Regex may be a special text string for describing a search pattern.

The extraction engine 202 may further receive one or more second NLP rules from a second NLP rules database 220. It may be noted that, in some embodiments, the second NLP rules database 220 may define part of speech (POS) for values of ground truth/attributes. For example, a POS associated the plurality of text entities may be identified. As it will be understood by those skilled in the art, the POS may be one of a noun, a pronoun, a verb, an adverb, an adjective, a conjunction, a preposition, and an interjection. Upon identifying the POS, one or more unique text entities may be selected from the plurality of text entities for which POS is a noun. The one or more (selected) unique text entities for which POS is identified as a noun may be extracted as relevant data.

For example, a salary slip document (input data) may include multiple text entities including the Name of the concerned person. Extracting the Name may be an objective of the extraction engine 202. Further, it will be understood that the Name shall fall under the POS category of a noun. As such, the text entities with noun as their POS shall be selected. The required name shall, therefore, be extracted from the selected entities.

In some embodiments, once an attempt of identifying the POS associated the plurality of text entities is made, one or more unique text entities may be identified for which POS is not identified. An entity type associated with each of the one or more unique text entities may be determined. The entity type may be a value entity or a pattern entity. Each value entity may have an associated value and each pattern entity has an associated pattern.

For example, an identified text entity may be made up of a combination of text characters indicative of a code name, like that of an e-mail ID or an oil well name (e.g., “john@gmail.com” or “AB-123”, respectively). As such, for such a text entity, no POS may be identified. Therefore, such a text entity may be identified either as a value entity or a pattern entity. As such, an e-mail ID (“john@gmail.com”) may be determined as a value entity, the value being the e-mail ID. This may be because the pattern of an e-mail ID is usually a typical and known pattern, and all the e-mail IDs may share the same or similar pattern. However, a text entity like “AB-123” corresponding to an oil well name may be determined as a pattern entity, since oil well names may share the same pattern, however, such a pattern may not be generally known, i.e., the NLP metadata extraction framework 200 may not have such a pattern prestored. Upon identifying a value entity, text entities in the input file having associated value same as the associated value of the value entity may be automatically identified. In other words, all the e-mail ID text entities may be identified and extracted.

Upon identifying a pattern entity, search pattern corresponding to a pattern (Regex) associated with the pattern entity may be automatically generated. Further, pattern associated with each of the plurality of text entities in the input file may be determined. The search pattern (Regex) corresponding to the pattern entity may be mapped with patterns associated with the plurality of text entities, and one or more matching patterns from the patterns associated with the plurality of text entities may be determined based on the mapping. The matching text entities corresponding to the one or more matching patterns may be extracted from the plurality of text entities.

For example, for a text entity “AB-123” corresponding to an oil well, a search pattern (Regex) “apd” (where, “a” signifies one or more alphabets, “p” signifies one or more punctuations, “d” signifies one or more digits) may be automatically generated. Further, patterns associated with other text entities in the input file are determined, the search pattern “apd” may be mapped with patterns associated with the other text entities, and matching patterns may be identified. Thereafter, all the text entities corresponding to the matching patterns are extracted. In this way, all the oil well names in the input file may be extracted.

In some embodiments, once the text data from the input file is identified, the first NLP rules may cause to receive a text input from a user for identifying relevant text entities from the plurality of text entities, and automatically generate a search pattern corresponding to the text input. The first NLP rules may further cause to determine a pattern associated with each of the plurality of text entities, and map the search pattern corresponding to the text input with patterns associated with the plurality of text entities. The first NLP rules may further cause to identify one or more matching patterns from the patterns associated with the plurality of text entities based on the mapping, and extract, from the plurality of text entities, relevant text entities corresponding to the one or more matching patterns.

For example, a user may provide a text input “AB-123” for identifying relevant text entities from the plurality of text entities extracted from the input file. A search pattern (Regex) “apd” may be identified for the input text entity “AB-123”. Further, patterns associated with other text entities in the input file may be determined, the search pattern (Regex) “apd” may be mapped with patterns associated with the other text entities, and matching patterns are identified. Thereafter, all the text entities corresponding to the matching patterns may be extracted. In this way, all the oil well names in the input file may be extracted.

It may be noted that, in some embodiments, the test input from the user may be received in form of an entry in a “Microsoft Excel” sheet. One or more rules may be defined that may automatically generate the search pattern (Regex) corresponding to the text input. Upon that, the one or more rules may determine a pattern associated with each of the plurality of text entities of the input file, map the search pattern corresponding to the text input with patterns associated with the plurality of text entities, identify one or more matching patterns from the patterns associated with the plurality of text entities based on the mapping, and extract, from the plurality of text entities, relevant text entities corresponding to the one or more matching patterns.

As such, in some embodiments, the “Microsoft Excel” data may be received from one or more “Microsoft Excel” sheets 222. The various rules (domain rules, NLP rules, location rules, etc.) may be applied to obtain extracted data 226. In some embodiments, “Microsoft Excel” macros may be used for extraction. Further, in some embodiments, the same macros may be embedded in Python (language). Here, the extracted data 226 may refer to relevant text entities extracted from the plurality of text entities, or expressions that may be generated based on the extracted relevant text entities using the various rules. In some additional embodiments, if the above approaches, i.e., the domain-based, location-based, POS-based, and Regex-based approach fails to provide text extraction, am Machine Learning (ML)-based approach may be used. For the ML-based approach, an Artificial Intelligence (AI) model (i.e., a ML model) 224 may be used.

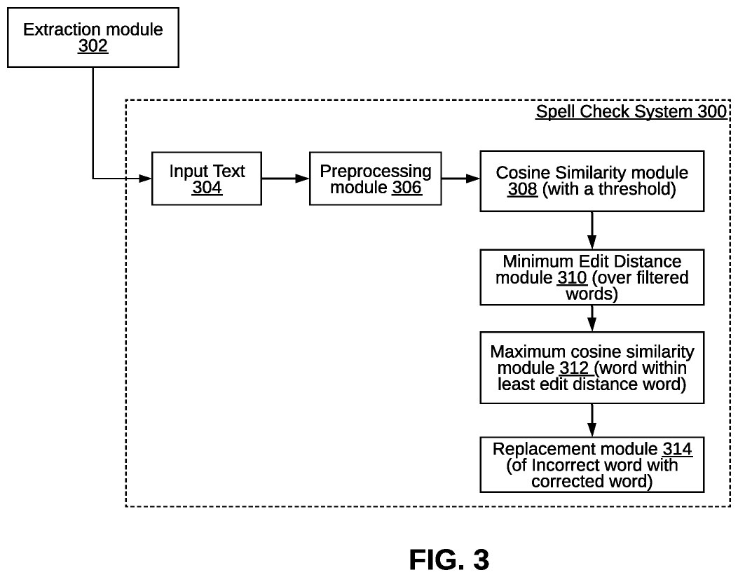

Referring now to FIG. 3, a block diagram of a spell check system 300 is illustrated, in accordance with some embodiments of the present disclosure. In some embodiments, text entities extracted by an extraction module 302 (corresponding to the text identification device 102) may be received by the spell check system 300. These expressions generated by extraction module 302 may act as input text 304 for the spell check system 300. The input text 304 may be preprocessed by a preprocessing module 306.

Upon preprocessing, a cosine similarity analysis may be performed on the preprocessed data, by a cosine similarity module 308. By way of an example, the cosine similarity module 308 may perform the cosine similarity analysis using a threshold. A minimum edit distance module 310 may perform minimum edit distance analysis on the data received from the cosine similarity module 308. In some embodiments, the minimum edit distance analysis may be performed on filtered words.

A maximum cosine similarity module 312 may perform maximum cosine similarity analysis on the data received from the minimum edit distance module 310. It may be noted that the maximum cosine similarity analysis may be based on a word within least edit distance word. A replacement module 314 may replace an incorrect word with a corrected word, based on the analysis performed by the maximum cosine similarity module 312.

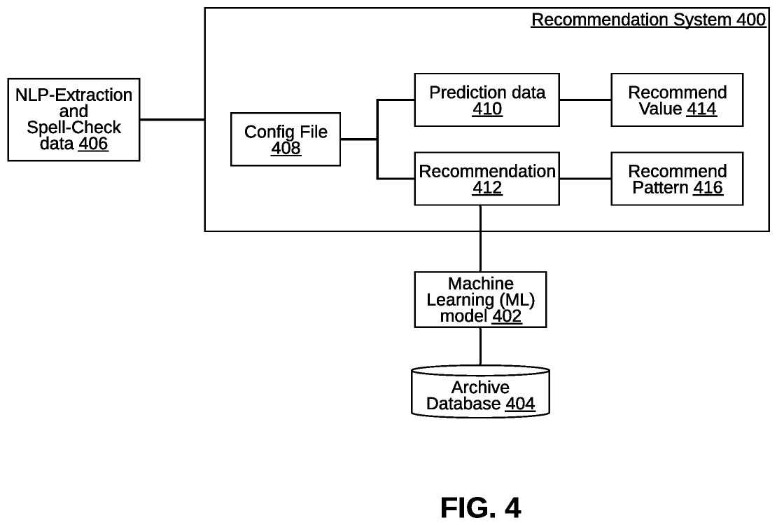

Referring now to FIG. 4, a block diagram of a recommendation system 400 is illustrated, in accordance with some embodiments of the present disclosure. For example, the recommendation system 400 may be used for identifying an entity type, i.e., value entity or pattern entity. In some embodiments, the recommendation system 400 may use a classification-based machine learning (ML) model 402. The recommendation system 400 may receive input data (NLP extraction and spell check data) 406. It may be noted that the input data may be data on which NLP and spell check has been performed. The recommendation system 400 may include a configuration (config) file 408. The config file 408 may trigger determining whether a value may be recommended or a pattern may be recommended for the input data.

The recommendation system 400 may feed the input data to the ML model 402. The ML model 402 may use historical data from an archive database 404. Based on the historical data, the ML model 402 may either provide a prediction data 410, or provide a recommendation data 412. As such, a recommended value 414 may be generated based on the prediction data 410, or a recommended pattern 416 may be generated based on the recommendation data 412.

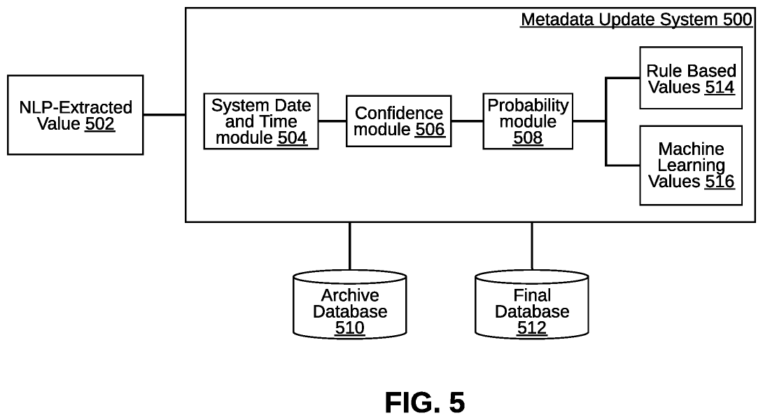

Referring now to FIG. 5, a block diagram of a metadata update system 500 is illustrated, in accordance with some embodiments of the present disclosure. In some embodiments, the metadata update system 500 may receive NLP-extracted data 502. The metadata update system 500 may include a system date and time module 504. The metadata update system 500 may further include a confidence module 506 and a probability module 508. The confidence module 506 may determine a confidence score associated with the accuracy of data extracted and expressions generated by the NLP rules. The probability module 508 may determine a probability score associated with the accuracy of extracted data and expressions generated by the NLP rules, based on the confidence score. In other words, the probability module 508 may determine a probability on how accurate/useful are the extracted data or expressions generated using the NLP rules.

If the probability as determined by the probability module 508 is high enough (i.e., greater than a threshold), then the data extracted and the expressions generated using the NLP rules, i.e., rule-based values 514, may be provided. However, if the probability, as determined by the probability module 508, is not high enough (i.e., less than a threshold), then data extracted and expressions generated using the ML model, i.e., Machine Learning (ML) values 516 may be provided. As mentioned earlier, the ML values may be generated by the ML model using historical data which may be stored in an archive database 510. The data extracted and the generated expressions may be stored in a final database 512.

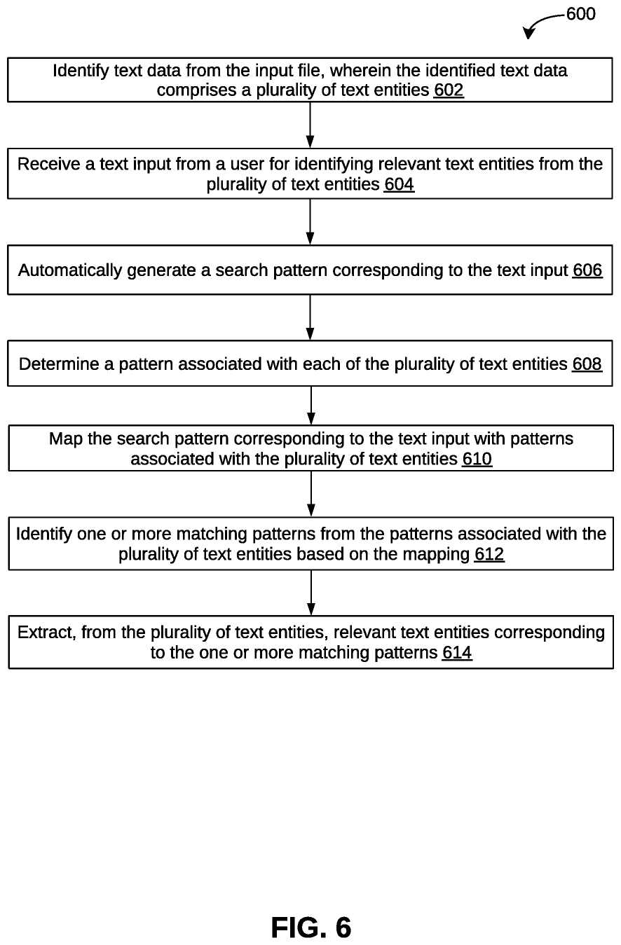

Referring now to FIG. 6, a flowchart of a method 600 of extracting information from contents of an input file is illustrated, in accordance with an embodiment of the present disclosure. As it will be understood, the method 600 may provide for a Regex-based method of text extraction. At step 602, text data may be identified from the input file. The identified text data may include a plurality of text entities. It may be noted that, in some examples, the input file may include at least one of an image file and a Portable Document Format (PDF) file.

At step 604, a text input may be received from a user for identifying relevant text entities from the plurality of text entities. For example, the user may provide the text as an entry in a “Microsoft Excel” sheet. At step 606, a search pattern (Regex) may be automatically generated corresponding to the text input. At step 608, a pattern may be determined associated with each of the plurality of text entities. At step 610, the search pattern corresponding to the text input may be mapped with patterns associated with the plurality of text entities. At step 612, one or more matching patterns from the patterns associated with the plurality of text entities may be identified based on the mapping. At step 614, relevant text entities corresponding to the one or more matching patterns may be extracted from the plurality of text entities.

Additionally, in some embodiments, upon extracting relevant text entities corresponding to the one or more matching patterns from the plurality of text entities, an expression may be generated using the extracted relevant text entities.

Further, a Machine Learning (ML) model may be used for extracting relevant entities, for example, when the method 600 is not able to extract the relevant entities. In other words, when no data (relevant text entity) can be extracted, the ML-based approach may kick in.

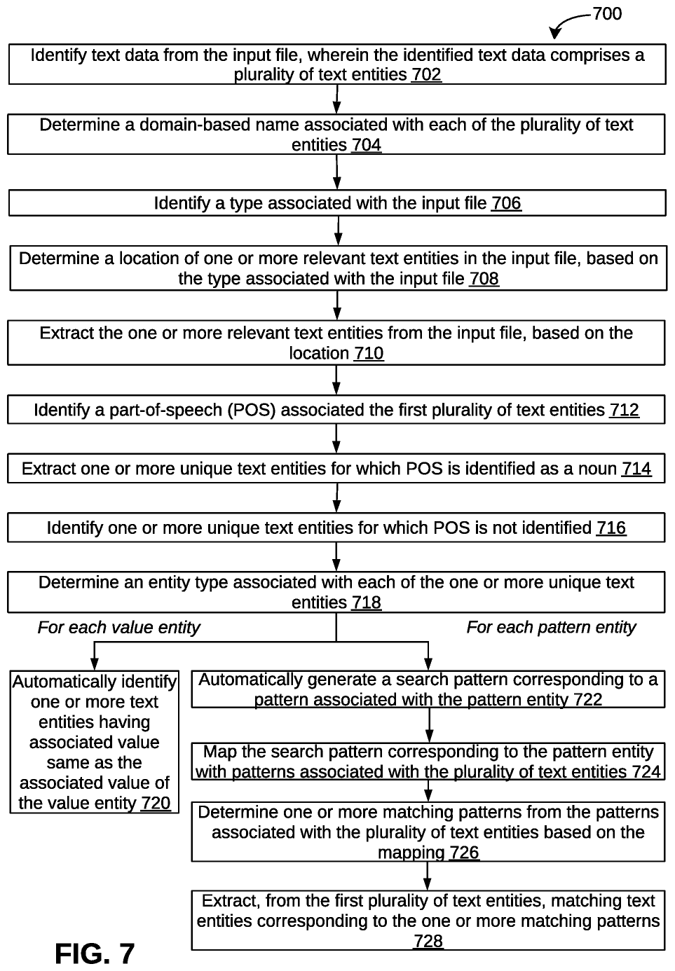

Referring now to FIG. 7, a flowchart of method 700 of extracting information from contents of an input file is illustrated, in accordance with another embodiment of the present disclosure. At step 702, text data may be identified from the input file. The identified text data may include a plurality of text entities. It may be noted that the input file may include at least one of an image file and a Portable Document Format (PDF) file.

At step 704, a domain-based name associated with each of the plurality of text entities may be determined. The domain-based name may be determined based on mapping each of the plurality of text entities with a list of domain-based names stored in a data depository. At step 706, a type associated with the input file may be identified. At step 708, a location of one or more relevant text entities in the input file may be determined, based on the type associated with the input file. At step 710, the one or more relevant text entities may be extracted from the input file, based on the location.

At step 712, a part-of-speech (POS) associated the plurality of text entities may be identified. It may be understood that the POS may be one of a noun, a pronoun, a verb, an adverb, an adjective, a conjunction, a preposition, and an interjection. At step 714, one or more text entities for which POS is identified as a noun may be determined.

At step 716, one or more unique text entities for which POS is not identified may be selected. At step 718, an entity type associated with each of the one or more unique text entities may be determined. The entity type may be one of a value entity and a pattern entity. Further, each value entity may have an associated value and each pattern entity has an associated pattern. As explained in conjunction with FIG. 4, a (ML-based) recommendation system 400 may be used for determining an entity type associated with each of the one or more unique text entities.

At step 720, for each value entity, one or more text entities having associated value same as the associated value of the value entity may be automatically identified. For each pattern entity, steps 722-728 may be performed. As such, at step 722, a search pattern (Regex) corresponding to a pattern associated with the pattern entity may be automatically generated. At step 724, the search pattern corresponding to the pattern entity may be mapped with patterns associated with the plurality of text entities. At step 726, one or more matching patterns may be determined from the patterns associated with the plurality of text entities based on the mapping. At step 728, matching text entities corresponding to the one or more matching patterns may be extracted, from the plurality of text entities.

It may be noted that the method 700 may be performed in conjunction with method 600. In an example scenario, the method 600 may kick in after the step 710 of the method 700 is completed and before the step 712 of the method 700 starts.

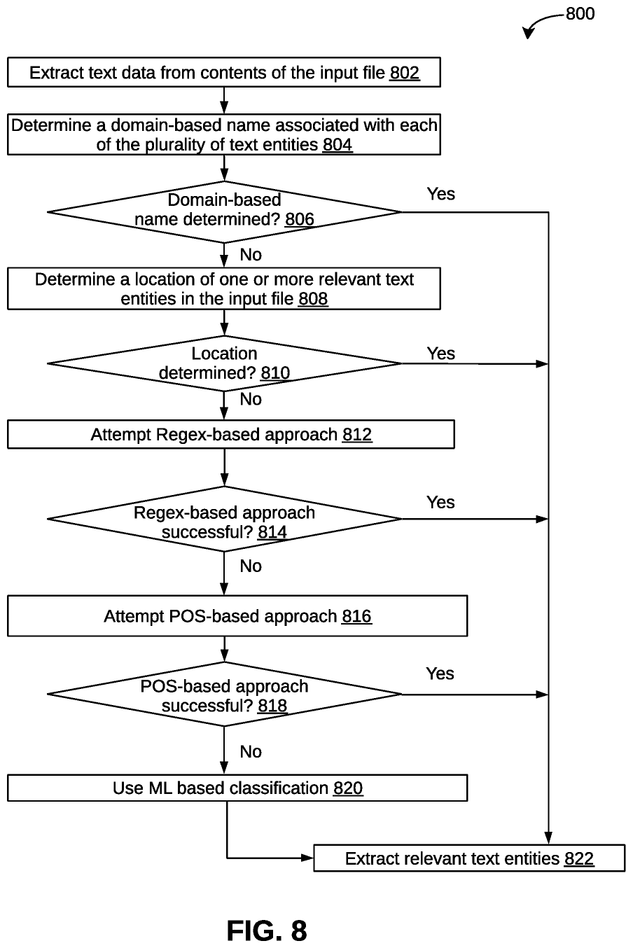

Referring now to FIG. 8, a flowchart of a method 800 of extracting information from contents of an input file is illustrated, in accordance with another embodiment of the present disclosure. At step 802, text data may be extracted from contents of the input file. The extracted text data may include a plurality of text entities.

At step 804, a domain-based name associated with each of the plurality of text entities may be determined. The domain-based name may be determined based on mapping each of the plurality of text entities with a list of domain-based names stored in a data depository. For example, when a PIN code is available, the city may be determined from the PIN code using the domain-based approach, for example, by mapping the PIN code with a list (of PIN codes and associated city names) stored in a knowledgebase. Similarly, a country name (e.g., India) may be determined when a city name (e.g., Delhi) is identified. In some embodiments, tags may be assigned to each of the second plurality of entities, accordingly.

At step 806, a check may be performed to check if the domain-based name is successfully determined or not. If the domain-based name is successfully determined, the method may proceed to step 822 (“Yes” path), where the identified text entities may be extracted. Further, expressions may be generated using the extracted text entities. If, at step 806, the domain-based name is not determined, the method may proceed to step 808 (“No” path). In other words, when a domain-based name cannot be identified, the method may proceed to take a next alternative approach.

At step 808, a value of a predetermined field may be determined based on location of each of the plurality of text entities. The location may be in form of (x and y) coordinates. By way of an example, the location may be predetermined based on a template stored in the data repository. For example, in some scenarios, value of a particular name may be written beside the name or beneath a particular name header, which may be identifiable based on the (x and y) coordinates. For example, in an “Aadhar card”, or a “PAN card”, or a driving license, the entities, for example, the name of the user may be available at a specific location, from where it could be identified. The location technique may be especially helpful in case of a Table, as the data in the Table is available in a structured format, and entities may be easily and accurately located. As such, first a type associated with the input file may be identified, i.e., if the input file is an “Aadhar card”, or a “PAN card”, or a driving license. Further, location of one or more relevant text entities in the input file may be determined, based on the type associated with the input file.

At step 810, a check may be performed to check if the location of one or more relevant text entities in the input file is successfully determined or not. If the location is successfully determined, the method 800 may once again proceed to step 822 (“Yes” path), where one or more relevant text entities from the input file may be extracted based on the location and expressions may be generated using the extracted text entities. If it is found that the location is not determined, at step 810, the method 800 may proceed to step 812.

At step 812, Regex-based approach may be attempted on the input to file to extract relevant text entities. To this end, a text input may be received from a user for identifying relevant text entities from the plurality of text entities, and a search pattern corresponding to the text input may be automatically generated. In other words, a Regex may be generated. Further, a pattern associated with each of the plurality of text entities may be generated, the search pattern (Regex) corresponding to the text input may be mapped with patterns associated with the plurality of text entities, and one or more matching patterns from the patterns associated with the plurality of text entities may be identified based on the mapping. In some embodiments, the method 800 may include calculating a probability of determining the relevant entity from the extracted text data, corresponding to the Regex.

At step 814, a check may be performed to determine if the Regex-based approach is successfully applied. If the Regex-based approach is successfully applied, the method 800 may proceed to step 822 (“Yes” path), where relevant text entities corresponding to the one or more matching patterns may be extracted from the plurality of text entities and expressions may be generated using the extracted text entities. If the Regex-based approach is not successful, the method 800 may proceed to step 816 (“No” path).

At step 816, a part-of-speech (POS)-based approach may be attempted. For example, POS associated with each of the plurality of text entities may be determined. In other words, at step 816, an attempt may be made to determine which of POS the entity may be associated with, for example, the POS may be a noun, an adverb, an adjective, etc. Further, at step 816, an attempt may be made to determine entity type associated with each of the one or more unique text entities. To this end, one or more unique text entities for which POS is not identified may be selected. For example, for unique entities having a combination of alphabets, digits, punctuations, etc. (such as e-mail IDs or oil well names discussed above), the POS may not be identified. For such text entities, an entity type associated with each of the one or more unique text entities may be determined. The entity type may be one of a value entity and a pattern entity. Each value entity may have an associated value and each pattern entity may have an associated pattern. Further, for each value entity, an attempt may be made to automatically identify one or more text entities having associated value (for example, e-mail ID) same as the associated value of the value entity.

At step 818, a check may be performed to determine if the attempt is successful (i.e., the POS-based approach is successful). If the attempt is found to be successful, the method 800 may proceed to step 822 (“Yes” path), where the one or more text entities (relevant text entities) having associated value same as the associated value of the value entity may be extracted and expressions may be generated using the extracted text entities.

Further, for each pattern entity, an attempt may be made to automatically generate a search pattern corresponding to a pattern associated with the pattern entity, map the search pattern corresponding to the pattern entity with patterns associated with the plurality of text entities, and determine one or more matching patterns from the patterns associated with the plurality of text entities based on the mapping. At step 818, a check may be performed to determine if the attempt is successful (i.e., the POS-based approach is successful). If the attempt is found to be successful, the method 800 may proceed to step 822 (“Yes” path), where the matching text entities corresponding to the one or more matching patterns may be extracted from the plurality of text entities and expressions may be generated using the extracted text entities. If at step 818, the POS-based approach is found to be not successful, the method 800 may proceed to step 820 (“No” path).

At step 820, an attempt may be made to extract relevant text entities (information) from plurality of text entities using a machine learning (ML) model. It may be understood that the ML model may be first trained to extract a type of relevant text entities. Therefore, an ML-based classification may be applied to the input file to extract relevant text entities, based on the training of the ML model. Accordingly, at step 822, relevant text entities may be extracted based on the ML-based classification, and expressions may be generated using the extracted text entities.

It may be noted that, in some embodiments, the various steps (i.e., steps 804, 808, 812, 816, and 820) may be performed in the sequence describe above, or any other sequence as well.

It may be further noted that the NLP-based approach may be used in the below scenarios:
(i) If a search key (i.e., text input from a user) is available, and its associated text extraction (i.e., relevant entity) is expected in the input file;
(ii) If a search key (i.e., text input from a user) is not available but its associated text extraction (i.e., relevant entity) is expected in the input file;
(iii) If a search key (i.e., text input from a user) is available, but its associated text extraction (i.e., relevant entity) is not expected in the input file;

It may be further noted that a confidence score (probability score) may be calculated in each of the approaches. For example, for a “Domain-based” approach, the maximum probability score (for example, 1) may be obtained when there is an exact match of the search key (i.e., text input from a user) with rest of the text entities ion the input file. Further, in the “Location-based” approach, the probability score (p) may be based on probability (w) of matching of the search key and identification of the location (I), p=w*I. The probability for location identification may be either be 0 or 1 for Regex-based approach, and the probability score of extracting (e) can be 1 or 0. Further, the extracted values can be multiple (n), and one out of those values may be selected. Hence, the probability of selected value may be: “1/n”, and the confidence score may be e*(1/n). When both “Location-based” and “Regex-based” approaches are used, then each approach may be given 50% weightage. Hence, the confidence score may be (w*I)/2+(e*(1/n))/2. For ML-based approach, the probability score may be derived based on Confusion Matrix (Accuracy Rate).

Further, a combined probability score (P) may be calculated when the following approaches are used: a pure word match approach, a Rules-based approach (i.e., one or more of domain-based, location-based, POS-based, and Regex-based approach), and a ML-based approach. Accordingly,
combined probability score (P)=(P1*0.3)*(P3*0.7), or
combined probability score (P)=(P1*0.3)*(P2*0.7), where,
P1=probability score of a pure word match approach,
P2=probability score of a Rules-based approach, and
P3=probability score of a ML-based approach.

Case Scenario 1

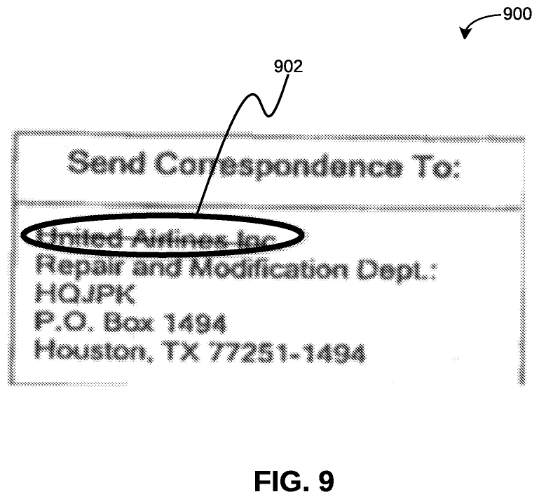

Referring now to FIG. 9, a snapshot of an exemplary input file 900 with a noisy entity 902 present in the input file 900 is shown. For example, a first part of an entity may not be legible because of smudging, or scratching, etc., and a second part of the entity may include the word “United”. As such, the actual entity could possibly be “United Airlines” or “United States”, etc. In order to determine this entity, one or more approaches (i.e., domain-based, location-based, POS-based, Regex-based, or ML-based) may be used for determining the actual entity. For example, if the domain-based, location-based, POS-based, and Regex-based approach fails to provide an extraction, the ML-based approach may kick in, and may provide a text extraction, based on based on historical data using a classification-based Machine Learning (ML) model. The ML-model may be a deterministic model and/or a probabilistic model.

### Case Scenario 2

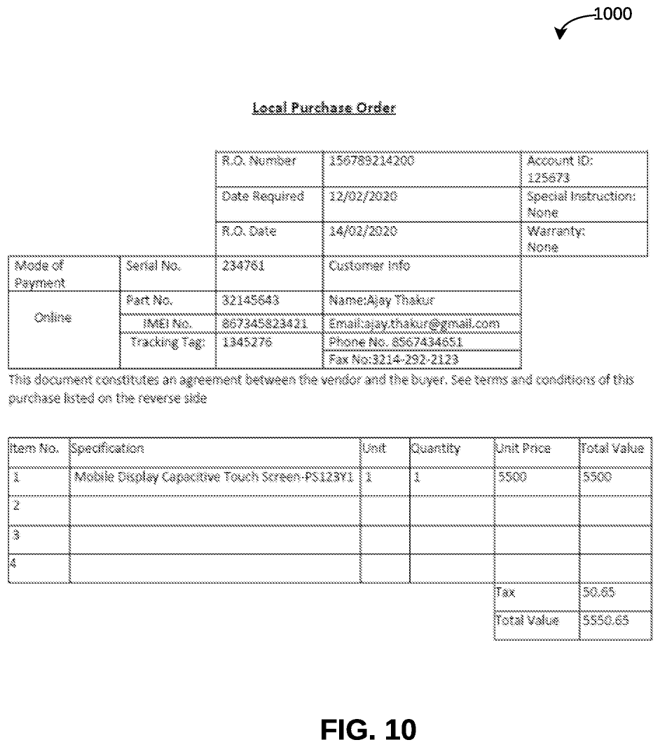

Referring now to FIG. 10, a snapshot of an input file “Local Order” 1000 is shown, from where various text entities may be required to be extracted. As shown in FIG. 10, the input file “Local Order” 1000 is in a tabular structure.

For example, in order to extract a value for the attribute “RO Number”, the “RO Number” may be extracted from a domain dictionary database (lookup table) 1002, by mapping the RO date attribute.

In order to extract the attribute Part Number, a key “Part Number” present in the input file 1000 may be identified or received as user input. Thereafter, by location-based approach, using the template information stored in the database, a possible location of the Part Number may be determined. For example, the location-based approach may suggest that the Part Number may be present on the “right” side of the input file 1000. Therefore, the required Part Number “32145643” may be extracted from the right cell coordinates of the tabular structure of input file “Local Order” 1000.

In order to extract the attribute e-mail ID present in the input file 1000, the Regex-based approach may be used. As such, a key (Regex) associated with the attribute e-mail may be identified or received from a database. As such, the Regex may be “apapapa” (“a” signifying one or more alphabets, “p” signifying one or more punctuations, and “d” signifying one or more digits), corresponding to the e-mail ID: “ajay.thakur@gmail.com”. Accordingly, the text entity with the matching pattern (Regex), i.e., of the email-ID may be identified, and the value (“ajay.thakur@gmail.com”) may be extracted from the corresponding cell of the tabular structure of the input file 1000.

In order to extract the attribute Name form the input file 1000, POS-based approach may be used. For example, a key present for the attribute (Name) may be first identified in the input file 1000. Thereafter, POS of the identified text entities in the input file 1000 may be determined, for example, using a Named Entity Recognizer (NER) tagger. A NER tagger specified in the database for the attribute Name may be searched. A text entity corresponding to the attribute Name (“Ajay Thakur”) having a POS noun may, therefore, be extracted. Accordingly, an expression using the extracted text entities “Ajay Thakur” may be generated.

One or more text extraction techniques are disclosed above for extracting information from contents of an input file. The above techniques provide one or more advantages over the conventional techniques. For example, the techniques provide for various approaches, i.e., a domain-based, a location-based, a POS-based, a Regex-based approach, and a ML-based approach for performing text extraction. The text extraction, therefore, can be performed using a single approach, or multiple approaches applied in any sequence. Further, the techniques allow to generate expressions using the extracted information. Further, the techniques allow for extracting information and generating expressions using the extracted information, even in complex documents, in which no tags are present or no pattern can be identified in the extracted information.

One or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of extracting information from contents of an input file, the method comprising:
identifying text data from the input file, wherein the identified text data comprises a plurality of text entities;
receiving a text input from a user for identifying relevant text entities from the plurality of text entities;
automatically generating a search pattern corresponding to the text input;
determining a pattern associated with each of the plurality of text entities;
mapping the search pattern corresponding to the text input with patterns associated with the plurality of text entities;
identifying one or more matching patterns from the patterns associated with the plurality of text entities based on the mapping; and
extracting, from the plurality of text entities, relevant text entities corresponding to the one or more matching patterns.

2. The method of claim 1, comprising generating an expression using the extracted relevant text entities.

3. The method of claim 1, wherein the input file comprises at least one of an image file and a Portable Document Format (PDF) file.

4. The method of claim 1, further comprising:
determining a domain-based name associated with each of the plurality of text entities, wherein the domain-based name is determined based on mapping each of the plurality of text entities with a list of domain-based names stored in a data depository.

5. The method of claim 1, further comprising:
identifying a type associated with the input file;
determining a location of one or more relevant text entities in the input file, based on the type associated with the input file; and
extracting the one or more relevant text entities from the input file, based on the location.

6. The method of claim 5, wherein the location is based on (x, y) coordinates, wherein the location is predetermined based on a template corresponding to a type associated with the input file, stored in the data repository.

7. The method of claim 1, further comprising:
identifying a part-of-speech (POS) associated the plurality of text entities, wherein the POS is one of a noun, a pronoun, a verb, an adverb, an adjective, a conjunction, a preposition, and an interjection; and
extracting one or more text entities for which POS is identified as a noun.

8. The method of claim 7, further comprising:
identifying one or more unique text entities for which POS is not identified; and
determining an entity type associated with each of the one or more unique text entities, wherein the entity type is one of a value entity and a pattern entity, wherein each value entity has an associated value and each pattern entity has an associated pattern.

9. The method of claim 8, further comprising:
for each value entity,
automatically identifying one or more text entities having associated value same as the associated value of the value entity.

10. The method of claim 8, further comprising:
for each pattern entity,
automatically generating a search pattern corresponding to a pattern associated with the pattern entity;
mapping the search pattern corresponding to the pattern entity with patterns associated with the plurality of text entities;
determining one or more matching patterns from the patterns associated with the plurality of text entities based on the mapping; and
extracting, from the plurality of text entities, matching text entities corresponding to the one or more matching patterns.

11. The method of claim 1, comprising generating a recommendation based on historical data using a classification-based Machine Learning (ML) model.

12. A system for extracting information from contents of an input file, the system comprising:
a processor; and
a memory communicatively coupled to the processor, wherein the memory stores processor-executable instructions, which, on execution by the processor, cause the processor to:
identify text data from the input file, wherein the identified text data comprises a plurality of text entities;
receive a text input from a user for identifying relevant text entities from the plurality of text entities;
automatically generate a search pattern corresponding to the text input;
determine a pattern associated with each of the plurality of text entities;
map the search pattern corresponding to the text input with patterns associated with the plurality of text entities;
identify one or more matching patterns from the patterns associated with the plurality of text entities based on the mapping; and
extract, from the plurality of text entities, relevant text entities corresponding to the one or more matching patterns.

13. The system of claim 12, wherein the input file comprises at least one of an image file and a Portable Document Format (PDF) file.

14. The system of claim 12, wherein the processor-executable instructions, on execution by the processor, further cause the processor to perform at least one of:
a domain-based extraction, wherein performing the domain-based extraction comprises:
determining a domain-based name associated with each of the plurality of text entities, wherein the domain-based name is determined based on mapping each of the plurality of text entities with a list of domain-based names stored in a data depository;
a location-based extraction, wherein performing the location-based extraction comprises:
identifying a type associated with the input file;
determining a location of one or more relevant text entities in the input file, based on the type associated with the input file; and
extracting the one or more relevant text entities from the input file, based on the location, wherein the location is predetermined based on a template corresponding to a type associated with the input file, stored in the data repository;
a part-of-speech (POS)-based extraction, wherein performing the part-of-speech (POS)-based extraction comprises:
identifying a POS associated the plurality of text entities, wherein the POS is one of a noun, a pronoun, a verb, an adverb, an adjective, a conjunction, a preposition, and an interjection; and
extracting one or more text entities for which POS is identified as a noun; and
a Machine Learning (ML)-based extraction, wherein performing the ML-based extraction comprises:
generating a recommendation based on historical data using a classification-based ML model.

15. The system of claim 14, wherein performing the part-of-speech (POS)-based extraction further comprises:
identifying one or more unique text entities for which POS is not identified;
determining an entity type associated with each of the one or more unique text entities, wherein the entity type is one of a value entity and a pattern entity, wherein each value entity has an associated value and each pattern entity has an associated pattern;
for each value entity,
automatically identifying one or more text entities having associated value same as the associated value of the value entity, for each pattern entity, and
for each pattern entity,
automatically generating a search pattern corresponding to a pattern associated with the pattern entity;
mapping the search pattern corresponding to the pattern entity with patterns associated with the plurality of text entities;
determining one or more matching patterns from the patterns associated with the plurality of text entities based on the mapping; and
extracting, from the plurality of text entities, matching text entities corresponding to the one or more matching patterns.

16. The system of claim 12, wherein the processor-executable instructions, on execution by the processor, further cause the processor to:
generate a recommendation based on historical data using a classification-based Machine Learning (ML) model.

17. A non-transitory computer-readable storage medium having stored thereon, a set of computer-executable instructions causing a computer comprising one or more processors to perform steps comprising:
identifying text data from the input file, wherein the identified text data comprises a plurality of text entities;
receiving a text input from a user for identifying relevant text entities from the plurality of text entities;
automatically generating a search pattern corresponding to the text input;
determining a pattern associated with each of the plurality of text entities;
mapping the search pattern corresponding to the text input with patterns associated with the plurality of text entities;
identifying one or more matching patterns from the patterns associated with the plurality of text entities based on the mapping; and
extracting, from the plurality of text entities, relevant text entities corresponding to the one or more matching patterns.

18. The non-transitory computer-readable storage medium of claim 17, wherein the set of computer-executable instructions causing the computer comprising the one or more processors to perform at least one of:
a domain-based extraction, wherein performing the domain-based extraction comprises:
determining a domain-based name associated with each of the plurality of text entities, wherein the domain-based name is determined based on mapping each of the plurality of text entities with a list of domain-based names stored in a data depository;
a location-based extraction, wherein performing the location-based extraction comprises:
identifying a type associated with the input file;
determining a location of one or more relevant text entities in the input file, based on the type associated with the input file; and
extracting the one or more relevant text entities from the input file, based on the location, wherein the location is predetermined based on a template corresponding to a type associated with the input file, stored in the data repository;
a part-of-speech (POS)-based extraction, wherein performing the part-of-speech (POS)-based extraction comprises:
identifying a POS associated the plurality of text entities, wherein the POS is one of a noun, a pronoun, a verb, an adverb, an adjective, a conjunction, a preposition, and an interjection; and
extracting one or more text entities for which POS is identified as a noun; and
a Machine Learning (ML)-based extraction, wherein performing the ML-based extraction comprises:
generating a recommendation based on historical data using a classification-based ML model.

19. The non-transitory computer-readable storage medium of claim 18, wherein performing the part-of-speech (POS)-based extraction further comprises:
identifying one or more unique text entities for which POS is not identified;
determining an entity type associated with each of the one or more unique text entities, wherein the entity type is one of a value entity and a pattern entity, wherein each value entity has an associated value and each pattern entity has an associated pattern;
for each value entity,
automatically identifying one or more text entities having associated value same as the associated value of the value entity, for each pattern entity, and
for each pattern entity,
automatically generating a search pattern corresponding to a pattern associated with the pattern entity;
mapping the search pattern corresponding to the pattern entity with patterns associated with the plurality of text entities;
determining one or more matching patterns from the patterns associated with the plurality of text entities based on the mapping; and
extracting, from the plurality of text entities, matching text entities corresponding to the one or more matching patterns.

20. The non-transitory computer-readable storage medium of claim 17, wherein the set of computer-executable instructions causing the computer comprising the one or more processors to perform:
generating of a recommendation based on historical data using a classification-based Machine Learning (ML) model.
